(19) United States
(12) Patent Application Publication
(10) Pub. No.: US 2006/0190973 A1
(43) Pub. Date: Aug. 24, 2006

(54) User-configurable multimedia presentation system

(76) Inventors: Kenneth Fernung, Westfield, IN (US); George Witwer, Bluffton, IN (US); Stephen Brooks, Carmel, IN (US); Michael Runyon, Brownsburg, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/064,992

(22) Filed: Feb. 24, 2005

(51) Int. Cl. H04N 7/173; G06F 13/00; G06F 3/00; H04N 5/445

(52) U.S. Cl. 725/87; 725/86; 725/60; 725/109; 725/110

(57) ABSTRACT

In one disclosed embodiment, multiple content sources are identified, and displays of content from those sources are positioned on a common display under user control. Content source selections and display preferences are persisted between user sessions, and fresh content is displayed each time the content is loaded. The user's customized display draws multimedia content from one or more selected sources from a predetermined list. In some embodiments, the multimedia content that is selectable for placement on the display includes television channels decoded from a cable TV signal by a converter.

### REFERENCE TO RELATED APPLICATIONS

This application contains subject matter related to U.S. patent applications Ser. No. 10/298,181, “Methods and Systems for Implementing a Customized Life Portal”; Ser. No. 10/298,182, “Customized Life Portal”; Ser. No. 10/298,183, “Method and System for Modifying Web Content for Display in a Life Portal”; and Ser. No. 10/961,314, “Clustering-Based Personalized Web Experience.”

### FIELD OF THE INVENTION

The present invention relates to computer graphics processing and selective visual display systems. More specifically, the present invention relates to a system for displaying multimedia content.

### BACKGROUND

Digital transmission of multimedia content has long been increasing in popularity. Digital transmission enables design of systems with error checking and correction, encryption, and other management provisions that are appropriate for the context of the delivery. Many such systems, however, place most (or even all) aspects of playback under the control of the provider or content source. While such systems provide advantages for content production, users are left with less ability to control operation of the systems on their end.

There is thus a need for further contributions and improvement to multimedia display technology, especially as it relates to user experience and control.

### SUMMARY

It is an object of the present invention to provide improved media display, systems, methods, software, and apparatus.

It is another object of the present invention to provide an improved method for displaying multimedia content on a user-configured display.

These objects and others are achieved by various forms of the present invention. In one embodiment, data is fetched from a content source identified in a library provided by a provider, though the content is not hosted by the provider, and is displayed with other content, retrieved from a second source that is not in a predetermined library provided by the provider. The identification of the selected data sources, as well as their relative placements in the display persist from one session to another. In some forms of this embodiment, playback states of multimedia content are also persistent between sessions.

Another embodiment of the present invention includes a simultaneous display of three or more multimedia streams, each with user-configurable size and position, and user control of playback (such as with play, pause, and stop controls).

Still another embodiment of the present invention is a device that includes a processor, memory, and software that the processor can execute to accept user identification of three or more digital video streams, retrieve each of the video streams via a digital video network, and simultaneously display each of the streams. This software can accept and carry out user instructions to position the display of each of the video streams, and accept and carry out user instructions to resize the display of each of the video streams. In some forms of this embodiment, the simultaneous display is achieved without need for a tuner.

Yet another embodiment of the invention is a method, including providing a list of sources for multimedia content, accepting a user selection of at least one source from the list of sources, accepting user identification of another content source (which identification is not limited to a predetermined list), and storing data that identifies the content sources. The stored data is then retrieved, and the content from the sources is obtained. The content is then displayed together in a single display. In one variation of this form, the user also indicates preferences for the source and relative positioning of the content streams in the unified display. These preferences are stored and retrieved with the content source information, and the display is generated in accordance with the user's indicated preferences.

### BRIEF DESCRIPTION OF THE DRAWINGS

FIG. 1 is a block diagram of a multimedia retrieval and display system according to one embodiment of the present invention.

FIG. 2 is a sample display according to one embodiment of the present invention.

FIG. 3 is a flowchart describing the development of a display and user thereof in one embodiment of the present invention.

FIG. 4 is a block diagram of a multimedia retrieval and display system according to another embodiment of the present invention.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, a computer is connected to a digital data network and a display device. A user selects sources of multimedia content, then configures the display of that content on the local display. In some embodiments, one or more other network-based sources of multimedia content are identified, and their streamed playback is juxtaposed with the playback of the other network-based content under the control of the user. In various embodiments described below, the positioning and playback of these multimedia streams is controlled by the user, and the user's preferences and selections are persisted between the user's sessions.

In this description, “multimedia content” refers to digital content that can be played to form a video and audio presentation. “Content” more generically refers also to text, audio-only material, HTML, and other electronically presentable material.

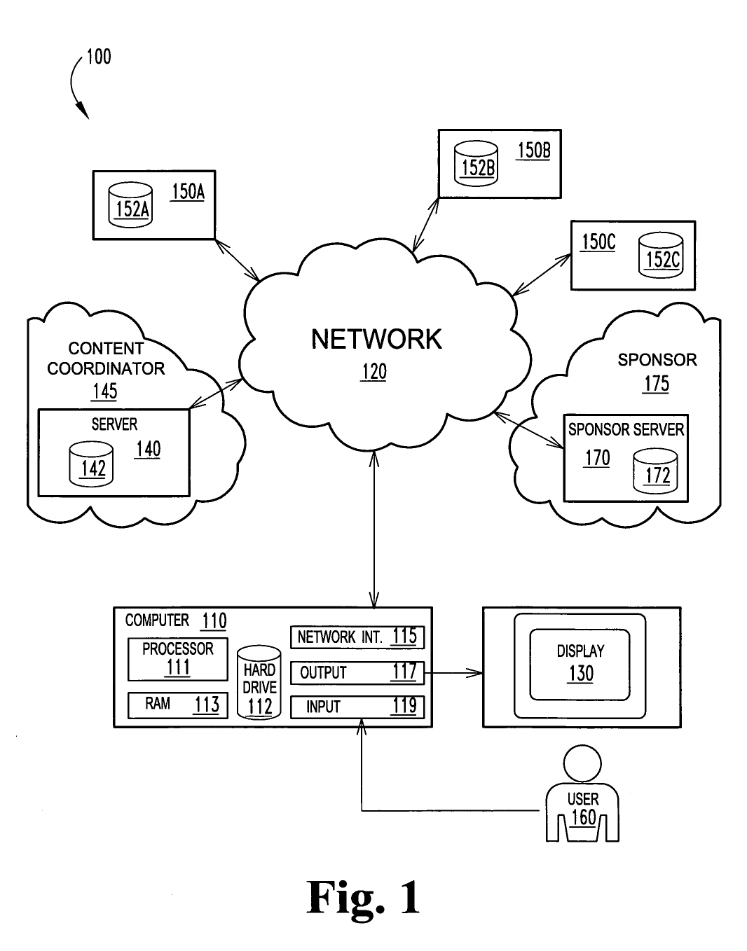

Turning specifically to FIG. 1, system 100 includes computer 110, which is connected to network 120 and display 130. Network 120 connects computer 110 to the content coordinator computer 140 and content source servers 150A, 150B, and 150C. Content coordinator computer 140 includes storage unit 142 and is controlled by a “content coordinator” entity 145, as will be discussed in further detail below. Content servers 150A, 150B, 150C each have their own respective storage devices 152A, 152B, 152C, respectively, but are not controlled by content coordinator 145. Sponsor 175 maintains another server 170 with its own storage device 172. User 160 uses the various input devices and observes display 130, as will be discussed in more detail below.

Computer 110 includes hard drive 112, processor 111, and memory 113, as well as network interface 115, output interface 117, and input interface 119, as are known by those skilled in the art. Power, ground, clock, sensors, and other signals and circuitry are not shown for clarity, but will be understood and easily implemented by those who are skilled in the art.

Processor 111 is preferably a microcontroller or general purpose microprocessor that reads its program from memory 113. Processor 111 may be comprised of one or more components configured as a single unit. Alternatively, when of a multi-component form, processor 111 may have one or more components located remotely relative to the others. One or more components of processor 111 may be of the electronic variety defining digital circuitry, analog circuitry, or both. In one embodiment, processor 111 is of a conventional, integrated circuit microprocessor arrangement, such as one or more PENTIUM 4 or XEON processors from INTEL Corporation of 2200 Mission College Boulevard, Santa Clara, Calif., 95052, USA, or ATHLON XP processors from Advanced Micro Devices, One AMD Place, Sunnyvale, Calif., 94088, USA.

Output device interface 117 provides a video signal to display 130, and may provide signals to one or more additional output devices such as LEDs, LCDs, or audio output devices, or a combination of types, though other output devices and techniques could be used as would occur to one skilled in the art. Likewise, optional input device 119 may include push-buttons, UARTs, IR and/or RF receivers, decoders, or other devices, as well as traditional keyboard and mouse devices. In alternative embodiments, one or more application-specific integrated circuits (ASICs), general-purpose microprocessors, programmable logic arrays, or other devices may be used alone or in combination as would occur to one skilled in the art.

Likewise, memory 113 can include one or more types of solid-state electronic memory, magnetic memory, or optical memory, just to name a few. By way of non-limiting example, memory 113 can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a recordable, rewritable, or read-only DVD or CD-ROM); a magnetically encoded hard disk, floppy disk, tape, or cartridge media; or a combination of any of these memory types. Also, memory 113 can be volatile, nonvolatile, or a hybrid combination of volatile and nonvolatile varieties.

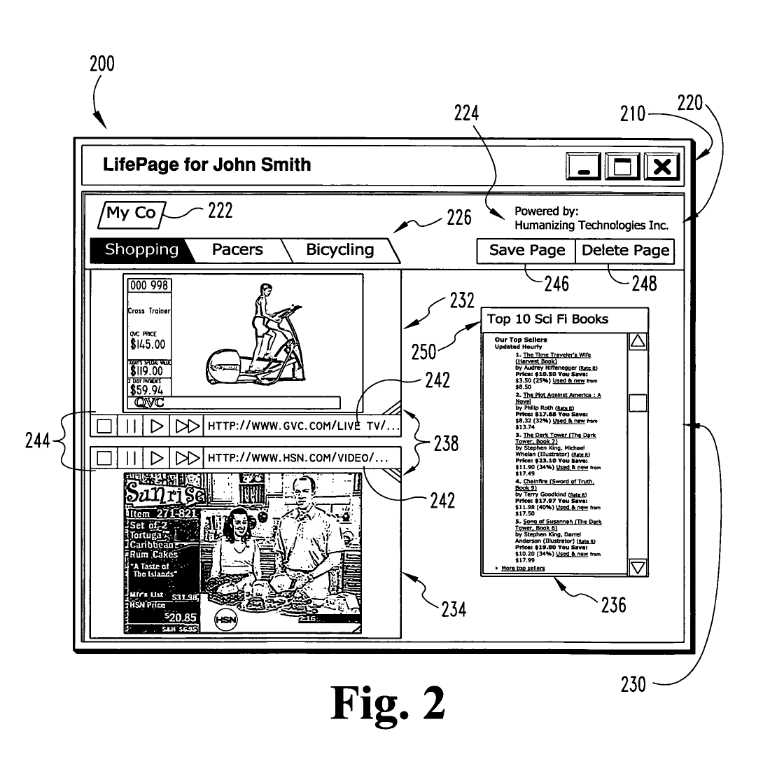

FIG. 2 shows an exemplary display according to one embodiment of the present invention. In some implementations of this embodiment, the display is created within a web browser window, building on technologies used for displays therein, while in others a custom, stand-alone application is provided to implement the techniques described below. As will be understood by those skilled in the art, a browser-based design leverages ubiquity of such technology, while the custom application enables the system to include additional features not readily available with standard browser technology.

FIG. 2 shows a LifePage display that has been customized by user 160 (“John Smith” for purposes of this discussion). Display 200 preferably includes a title bar 210 that identifies the user, reinforcing the user-centric nature of this embodiment. Header area 220 identifies the sponsor 175 for the page with logo 222, which may reflect sponsorship of an internet service provider (ISP), employer, or other entity. The content coordinator 145 is identified by designation 224, which reflects the entity that coordinates the content libraries and technology for use on LifePages such as these. In alternative embodiments, the sponsor indicated at 222 may also be content coordinator 145, so one or both of logo 222 and designation 224 may be omitted.

Tabs 226 are used to select collections of content and display parameters, which collections are typically organized in groups by general subject matter, here illustrated as including “Shopping,” “Pacers,” and “Bicycling,” which might be hobbies and interests of user 160. The selected collection at any given time may be indicated by shading or coloring of the background for the selected tab, changing the font of the label in the selected tab, darkening the border of the selected tab, or by other means as would be understood by those skilled in the art.

When a tab is selected, the associated plurality of content sources are polled, and the content is displayed in region 230 of display 200. In this example, region 230 displays a live video feed from the QVC shopping network at area 232, another live video feed from the Home Shopping Network (HSN) in area 234, and a live “top ten” list of science fiction books from Amazon.com in area 236. Each video feed is placed by the user by a drag-and-drop on a border of area 232, 234, or 236, and can be resized using sizing controls 238. The web address from which the feed is taken is shown in text controls 242, and playback of each stream is independently controlled using media controls 244.

As discussed further below, the relative (or absolute) position of each content area is saved either automatically at the end of each session, or manually when the user presses “Save Page” button 246. The collection of sources and positions can be deleted by user 160 by clicking on “Delete Page” button 248. It will be understood by those skilled in the art that other control configurations and user interface elements may be used to achieve the same or additional purposes without changing the underlying qualities of the present system.

Displays such as that shown in FIG. 2 are preferably developed by user 160, either from a pre-composed page or from scratch. The content coordinator 145 preferably provides a list of sources of multimedia and other content, including sources as shown in FIG. 2. In one mode of operation, the system provides a directory of sources by category and subcategory that the user can navigate via a GUI, and from which the user selects one or more sources. In the example shown in FIG. 2, areas 232 and 234 present content that originates from such a list. Though these sources are pre-selected by content coordinator 145, the actual selection, positioning, sizing, and playback are still within the control of user 160, as discussed herein.

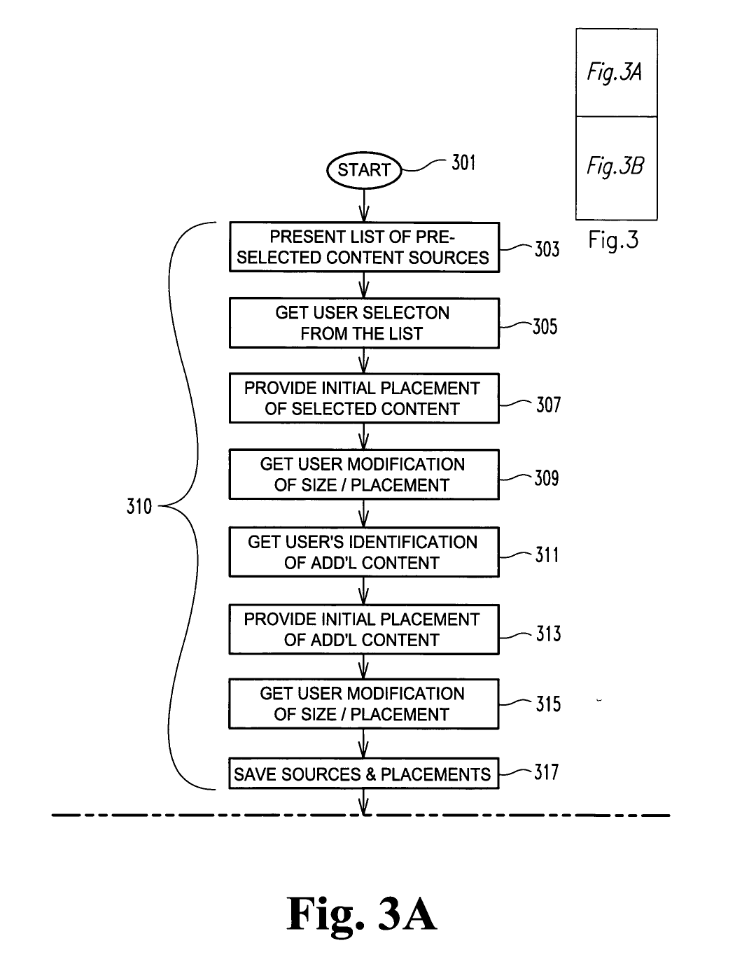

In contrast, the content shown in area 236 of display 200 is drawn from a source that is “manually” identified by user 160. For purposes of this disclosure, “manual identification” includes both direct entry of a URL by user 160 by typing, by drag-and-drop from a URL object source, or other method of selection from a broad universe of content that is not limited to a predetermined list that the content coordinator 145 gives the user 160, as will be discussed further below in relation to block 331 in FIG. 3. Like content from the pre-listed sources, however, the content displayed in area 236 can be positioned, sized, paused, stopped, and restarted according to the preferences of user 160.

The method executed in one embodiment of the present invention will now be discussed with reference to the flowchart of FIG. 3, with continuing reference to the components of system 100 in FIG. 1 and display 200 in FIG. 2. Method 300 begins at START point 301, typically after a user signs up for service. At block 303, the user is presented with a list of pre-selected content sources that have been determined by content coordinator 145 to be usable or desirable for use in a LifePage. For example, in this embodiment, the content sources in the list relate to a particular expressed interest of user 160, as determined from the context of the content identified therein, as well as technical compatibility between the format of content provided by that source and the framework itself. The user indicates a selection from the list at block 305, preferably by selecting that source with a pointing device and clicking a “next” button on the user interface to move forward with selection and placement.

The system then provides an initial placement of the selected content at block 307, preferably substantially filling the content display area 230, though not completely filling it. This preferred user interface technique implies to users that the display area is movable within display region 230. The content area includes a title bar 250 that functions as a handle for moving the content display area using a drag-and-drop gesture, as is understood by those skilled in the art. Resize control 238 is added to one or more comers of the content display area for resizing using similar dragging gestures. The user 160 may optionally modify the sizing and placement of the content area at input block 309 before adding more content to the display.

At block 331, the system allows user 160 to identify additional content for display on the LifePage. This identification may take the form of manual typing of a URL, dragging and dropping URL objects or data from other user interface sources, selection from a context menu bound to a hyperlink, or more complex view development as described in U.S. patent application Ser. No. 10/298,182. Other methods of selection (in block 305) and identification (in block 311) will occur to those skilled in the art, and may be used in this embodiment without undue experimentation.

The system provides initial placement of additional content in the new display area at block 313, preferably including a title bar and a resizing control as discussed above. The user may then optionally modify the size and placement of the new display area at block 315, and the system saves the content sources and the placement of the display areas at block 317.

User 160 may further modify the source selection and display layout before or after the sources and placements are saved, and more than two sources may preferably be identified, either as selections from the list of pre-selected multimedia content sources (as discussed at blocks 303 through 309) or by other identification means (as discussed at blocks 311 through 315). In preferred embodiments, the source selections and sizing and placement of content areas are automatically saved after each change, and the display is updated to show the content as placed by the user in substantially real time.

Further, those skilled in the art will appreciate that the user's preferences for source selection and display layout may be stored using one or more of a wide variety of methods. In one preferred embodiment, this data is stored by client-side software in one or more browser cookies, or in a configuration file (such as the registry in WINDOWS operating systems distributed by Microsoft Corporation). In alternative embodiments, the data is stored (in some cases redundantly) on content coordinator server 140 in storage 142, and/or on sponsor server 160 in storage device 162. Preferred embodiments also display freshly retrieved content from each source for display in the respective content display areas when each area is initially placed (see blocks 307 and 313 above), and update the content at regular intervals while the page is being displayed on device 130.

The steps 301-317 in method 300 just described comprise a first user session 310 wherein, generally speaking, the user picks content that he or she wishes regularly to see, and arranges that content as he or she desires. Later, in a second user session 320, those preferences are retrieved, the content is updated from the selected and identified sources, and the user's display is provided as will now be discussed.

When user 160 indicates a desire to view his or her LifePage, such as by opening a browser or custom application, or by navigating a browser to the LifePage, the LifePage framework is displayed at page 319. The selected content is retrieved at block 321, and the additional content is retrieved at block 323. Those skilled in the art will appreciate that the retrieval of content from a plurality of sources at blocks 321 and 323 may be accomplished in serial or in parallel, and will preferably include all content sources to be shown in the display. In preferred embodiments, the selected content retrieved at block 321 comprises one or more multimedia streams, which continue to be retrieved in a streaming fashion as other blocks in method 300 are processed.

The retrieved content is displayed at block 325 using the saved placement data, so that updated content is shown to user 160 with the size and position the user has indicated (for example, at blocks 309 and/or 315). The user may then provide additional instructions (such as by the pointer device gestures described above herein), and those instructions are interpreted at block 327, where the system determines whether the instruction changes the position or size of one or more content displays. If the instruction is a repositioning command, the details of the command are retrieved from the operating system at block 329, then are applied at block 331 by changing the position of the content area accordingly. Method 300 then continues by updating the display at block 337.

If the instruction interpreted at block 327 is a resizing command, the details of the command are obtained from the operating system at block 333, then applied at block 335 by changing the size of the content display area accordingly. Again, method 300 continues by updating the display at block 337. Those skilled in the art will appreciate that additional and different commands would be interpreted by the user interface in various embodiments.

The system then determines at block 339 whether more configuration commands have been received. If so, the system returns to block 327 so that another command can be interpreted and executed. If not, the configuration is saved at block 341, and the method ends at END point 399. It will be appreciated by those skilled in the art that in various embodiments the configuration can automatically be saved at one or more additional points in process 300, and that more user sessions will preferably be encountered. Some user sessions are likely simply to display the user's selected and identified content without any configuration changes. In other user sessions, the content display may be changed (as discussed in relation to user session 320), and content sources may be added to or removed from use in relation to the display.

In a preferred embodiment, the playback states of multimedia streams are saved at the end of each user session and restored at the beginning of the next session by that particular user. This way, if a user has chosen to pause or stop playback of a stream during one session, his or her preferences are also applied in the next session. In some embodiments, this data is preferably stored and retrieved as an array of states for the specified content, using one or more techniques that would occur to those skilled in the art. Certain of these embodiments save and restore the position of each stream, while others more simply stop a stream at the moment the new session begins if the stream was stopped or paused at the time the prior session ended.

Those skilled in the art will also appreciate that this preferred embodiment provides far greater freedom to users to select, arrange, and display content they want to see, as compared to many other “customizable home page” services that are known in the art. Furthermore, the use of pre-selected sources for multimedia content allows the content coordinator 145 to manage bandwidth, content, type, display technology requirements, and other demands and requirements of the system.

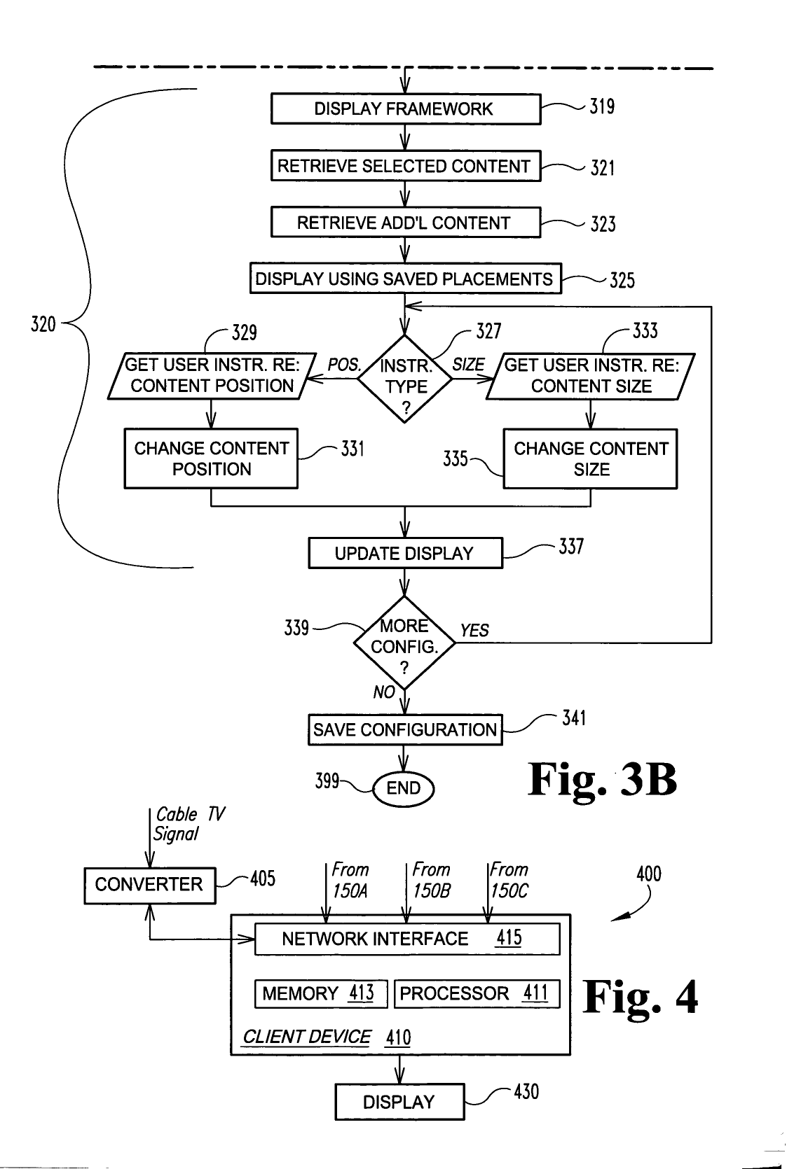

FIG. 4 illustrates an alternative embodiment of the present invention, and it will now be discussed with continuing reference to certain elements of FIG. 1. In this embodiment, multimedia content from a cable television feed can be displayed in conjunction with other selected and identified content as discussed above in relation to FIGS. 1-3. Here, a cable TV signal is accepted by a special converter 405 that converts the signal into one or more digital video streams. The streams are provided to network interface 415, which preferably forms a part of client-side device 405, analogous to computer 110 in FIG. 1. Client device 410 provides a video output signal for use by display 430, which displays the selected and identified multimedia streams for the user 160. Memory 413 in client device 410 is encoded with programming instructions executable by processor 411 to carry out a variation of method 300 (as was shown in FIG. 3). It is noted that processor 411 and memory 413 may be of any of the types discussed above in relation to processor 111 and memory 113, respectively. In some embodiments, processor 411 is of the same type as a processor 111 within the same broad system, while in others, different types of processors are used.

In system 400, video signals from content sources 150A, 150B, and 1SOC may be selected, sized, and positioned by the user, and video feeds arriving via converter 405 can be combined therewith into a single display on display device 430. Converter 405 preferably accepts digital and/or analog video signals for multiple channels via a single port, decodes selected channels from those carried on the signal, and provides digital video streams to client device 410 via network interface 415 for including in the display sent to display device 430. In this embodiment, the selection by user 160 of multimedia streams from the predetermined list preferably includes the option to use television channels from the cable TV signal in the display. When this option exists, and converter 405 is properly connected, client device 410 provides control information to converter 405 via network interface 415 so that the correct channel(s) can be converted to digital video. Converter 405 then sends the selected channels as video streams until circumstances no longer require them. Channel discovery and program guide information may be included in the content source list, arriving from content coordinator 145, through the cable TV signal, from an internet-based source, or from elsewhere as would occur to one skilled in the art.

In variations on these embodiments, content that is displayed in various content areas may come, as directed by the user, from internet-based multimedia feeds, decoded/converted television feeds, locally stored files (including, for example, video files, audio files, office documents, e-mail folders, and the like), RSS feeds, and other sources as would occur to one skilled in the art. Likewise, the library or list of content sources given by content coordinator 145 includes, in various embodiments, single-media content, multimedia content, streaming media, static content, dynamic content, and any combination thereof. Further, in various embodiments, a variety of client devices implement the present invention. For example, a general-purpose personal computer might be used with a monitor for display in one embodiment, while in other embodiments a television-based interface device (WEB-TV, for example) is used. In some devices, a PC-type operating system is used, while in others a different type of operating system is used, and in still others no distinct operating system is present.

In other variations, a plurality of sources, positions, sizes, and playback states selected by user 160 are stored and restored as a “collection.” User 160 defines, changes, deletes, selects, and manages multiple collections via a unified interface, such as through the use of tabs 226 (see FIG. 2) and other interface elements.

In still other variations, content of any streaming type is accepted by the system. The library of sources presented by content coordinator 145 (see FIG. 1) includes a variety of streaming media in some embodiments. In others, converter 405 accepts streaming content and provides one or more output streams for use in the disclosed system.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is claimed is:

1. A method of generating a user-configured display, comprising:
accepting selection of a first source of multimedia content by a user from a library of sources, the library being supplied by a provider;
fetching first data from the first source, where the first content source is not hosted by the library provider;
accepting input of a second content source by the user, wherein the input is not limited to a predetermined collection of sources;
fetching second data from a second content source;
playing the first data and displaying the second data together in a single display; and
accepting user control of the playing of the first data.

2. The method of claim 0,
wherein the accepting, fetching, and displaying occur during a first user session, and further comprising:
storing source identification data for the first source and the second source;
retrieving the source identification data in a second user session; and
based on the retrieved source identification data, fetching and displaying data from the first source and the second source together in the second user session.

3. The method of claim 0,
wherein the user control of the display puts the display of the first data and the second data in an array of states during a first user session,
and further comprising:
storing the array of states; and
restoring the array of states of the streams in a second user session.

4. The method of claim 0, wherein the first source is one or more digital video streams produced by a converter that takes a cable television signal as input and provides the one or more digital video streams as output.

5. The method of claim 4, wherein:
the converter provides two or more digital video streams as output,
each of the video streams corresponds to a television channel from the cable television signal, and
the first source is the two or more digital video streams.

6. The method of claim 4, wherein access to the one or more digital video streams provided by the converter is limited to devices attached to a local area network.

7. An apparatus, comprising a processor, a memory accessible to the processor, and programming instructions stored in the memory, the instructions being executable by the processor to:
accept user identification of sources for three or more digital video streams;
retrieve each of the video streams via a digital data network;
simultaneously display each of the video streams;
accept and carry out user instructions to position the display of each of the video streams relative to the others; and
accept and carry out user instructions to resize the display of each of the video streams.

8. The apparatus of claim 7, wherein one or more of the video streams comes from a converter that accepts a cable television signal as input and provides the one or more video streams as output.

9. The apparatus of claim 8, wherein the cable television signal includes a plurality of analog television signals.

10. The apparatus of claim 8, wherein the cable television signal includes a plurality of digital television signals.

11. The apparatus of claim 7, wherein the step of accepting user identification of sources includes limiting at least one of the identifications to a predetermined collection of sources.

12. The apparatus of claim 7, further comprising persisting the user-identified sources from one user session to another.

13. The apparatus of claim 7, further comprising persisting the user's instructions relating to positioning of the display of each of the video streams from one user session to another.

14. The apparatus of claim 7, further comprising persisting the user's instructions relating to the sizing of the display of each of the video streams from one user session to another.

15. The apparatus of claim 7, further comprising:
accepting user commands to change the state of the playback of each of the video streams; and
persisting the playback state of each of the video streams from one user session to another.

16. A method, comprising:
providing a predetermined list of sources for multimedia content;
accepting a user selection of a first source from the list of sources;
accepting a user identification of a second content source, wherein the identification is not limited to a predetermined list;
storing data that identifies the user-selected content source and the user-identified content source;
retrieving the stored data;
after the retrieving, obtaining first content from the user-selected content source, and second content from the user-identified content source; and
displaying the first content and the second content together in a unified display.

17. The method of claim 16, further comprising accepting a user indication of preferences for the relative positioning of the first content and the second content;
wherein:
the stored data also reflects the user's display preferences; and
the displaying is done in accordance with the user's display preferences.

18. The method of claim 16, further comprising accepting user control of playback states of the first content and the second content;
wherein:
the stored data also reflects the playback states; and
the displaying includes restoring the playback state for each of the first content and the second content.

19. The method of claim 16, wherein the first stream contains streaming multimedia content.
